(19) United States
(12) Patent Application Publication
(10) Pub. No.: US 2004/0044564 A1
(43) Pub. Date: Mar. 4, 2004

(54) Real-time retail display system

(76) Inventors: Paul H. Dietz, Hopkinton, MA (US); Shane Leslie Mihelic-Booth, Somerville, MA (US)

Correspondence Address: Patent Department, Mitsubishi Electric Research Laboratories, Inc., 201 Broadway, Cambridge, MA, 02139, US

(21) Appl. No.: 10/644,414

(22) Filed: Aug. 20, 2003

Related U.S. Application Data
(60) Provisional application No. 60/406,167, filed on Aug. 27, 2002.

(51) Int. Cl. G06F 17/60

(52) U.S. Cl. 705/10; 705/9

(57) ABSTRACT

In a real-time retail display system, displays are updated with content in an interactive manner based upon current behavior of the consumers and historical trends. A network of sensors provides real-time information to the system, including a combination behavioral and demographic data. Based upon available data, the system updates the displays as a function of the content presented, demographic information, and consumer behavior.

### RELATED APPLICATION

A claim of priority is made to U.S. Provisional Patent Application Serial No. 60/406,167, filed by Dietz et al. on Aug. 27, 2002, titled Projector Base Display System.

### FIELD OF THE INVENTION

This invention relates generally to retail display systems, and more particularly to retail display systems that dynamically adapt environments to consumer behavior.

### BACKGROUND OF THE INVENTION

There has been considerable prior work in constructing displays, sensing consumer characteristics and behavior and data mining techniques for preference prediction.

Bodin, in U.S. Published Application 20030040922 describes a system that alerts a consumer to nearby products that match the previously stored preferences of the identified consumer. That system needs to know the explicit identity of the consumer in order to access the database, and inherently assumes that the preferences have not changed.

Eldering, in U.S. Published Application 20030004810, describes a system that requires explicit knowledge of the consumer's identity to determine the applicability of an advertisement.

Sone, in U.S. Published Application 20020035560, describes a system that uses an RFID tag to explicitly identify a consumer and then present advertisements in a preferential format.

Black, in U.S. Published Application, 20020138433, describes a system that detects signals from personal wireless devices in order to recognize the presence of explicitly identified individuals, and then puts up appropriate advertising on an ATM screen.

Bermel, in U.S. Published Application, 20010038034, describes a method that updates a display based on the presence of electronic cards that explicitly identify individuals in the vicinity.

Loof, in U.S. Patent 6,507,279, describes an integrated self-checkout system that can present information to identified individuals. That system requires the individual to be a member of an explicitly authorized group as listed in a database.

All of those prior art systems inherently depend upon stored data about explicitly identified individuals.

### SUMMARY OF THE INVENTION

The present invention provides a system that uses computer-driven displays to present consumers with a variety of content to positively influence their purchase decisions. Unlike conventional signage and in-store video systems, the displays are interactive and constantly changing based upon a current behavior of the consumers and historical trends. Because the system responds to normal shopping behavior, there is nothing for the consumer to learn to operate, nor is there any need to carry any special device or special identification such as credit cards.

A network of sensors provides real-time information to the system. These sensors determine both consumer characteristics and behavior. Other information sources can also be utilized to supplement this data. These can include sensors that acquire environmental data such as weather, date, time, pricing, cash register receipts, and traffic data.

Based upon the available data, the system generates a dynamic model of consumer response as a function of the content presented. The model is used to optimize the presented content in order to achieve predetermined goals, such as maximizing total profits.

### BRIEF DESCRIPTION OF THE DRAWINGS

FIG. 1 is a block diagram of a real-time retail display system according to the invention;

FIG. 2 is a flow diagram of a method for operating the system of FIG. 1; and

FIG. 3 is a diagram of a retail environment where the system of FIG. 1 is used.

### DETAILED DESCRIPTION OF THE PREFERRED EMBODIMENT

System Structure

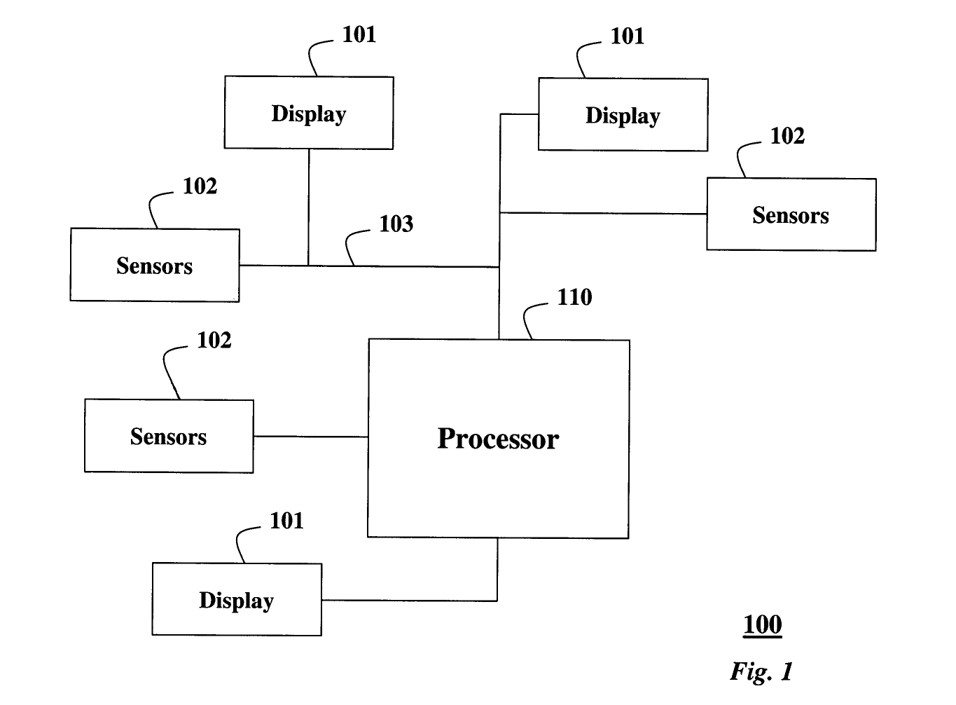

FIG. 1 shows a real-time retail display system 100 according to the invention. The system includes a processor 110 coupled to displays 101 and sensors 102. The processor is conventional in structure, and includes memory and input/output interfaces. The processor can also include a database and a network interface.

Each display can include one or more projectors to show still images or videos, audio outputs, signage, mechanical devices such as controllable mannequins, models, scent generators, or any other device configured to excite the human senses, in various combinations. The displays can be integrated with product arrangements, such as shelving, tables, counters and racks.

Thus, by a ‘display’, we mean an output device that stimulates human senses.

The sensors can include, but are not limited to proximity sensors, microphones, thermal sensors, cameras, touch and motion sensors. The sensors 102 are configured to determine consumer characteristics and behavior in the vicinity of the displays 101. Note that there is no need to explicitly identify the consumer. It is sufficient to detect broad classifications such as gender, height, weight, and age. Other sensors can also be integrated to provide environmental data such as weather, traffic, time, date, pricing, sales, etc.

The displays and sensors are connected to the processor by a network 103. The network can be wired or wireless.

System Operation

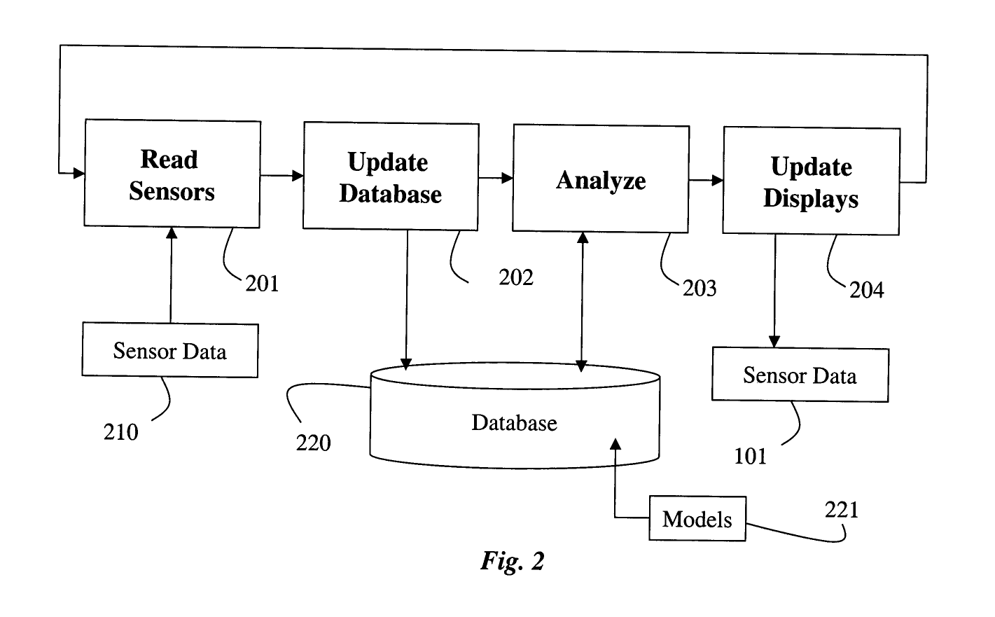

The basic operation of the processor 110 is shown in FIG. 2. The system reads 201 sensor data 210, updates 202 a database 220, analyzes 203 the database, and updates 204 the displays 101 according to the analysis. The database can include preference models 221 for consumers, or classes of consumers as described in greater detail below.

It should be noted that the preference models according to the invention do no rely on explicit consumer identification, such as knowing the consumer name, account number, credit card number, etc. Instead, the preference models according to the invention are built from consumer characteristics which are relatively straightforward to detect, such as height, weight, gender, race, and the like. This allows the system to respect the privacy of the individual. Thus, our system operates according to real consumer characteristics, e.g., gender and race, and not to some assigned identity, such as an account number.

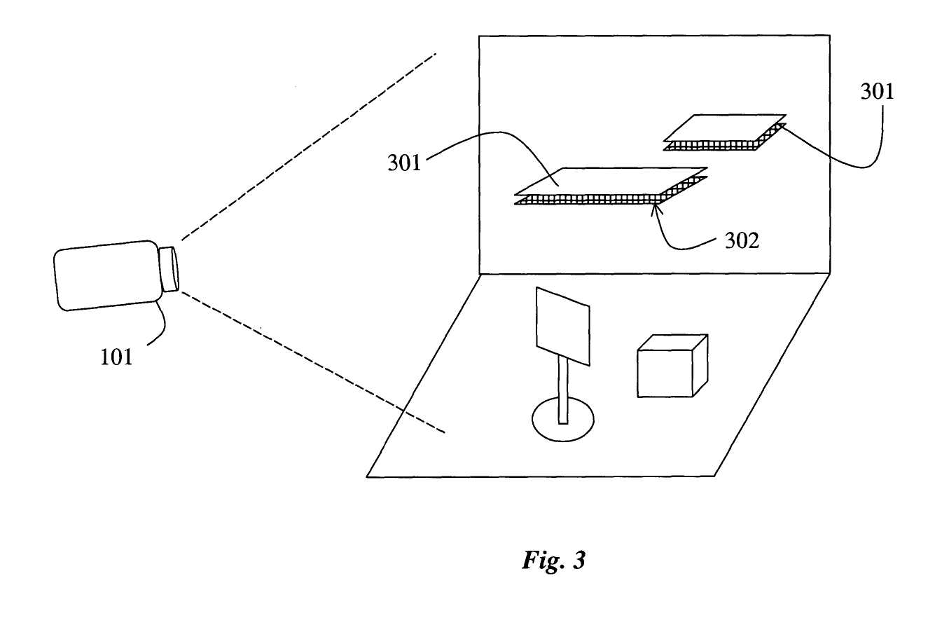

FIG. 3 shows a display with a projector as an element of the display system. Although video projectors are typically used for rendering images on a planar display surface, it is also possible to project images onto three-dimensional structural elements such as shelves, walls, signage, and products. Multiple projectors can be used to increase the size of the displayed images. The images can be warped and blended so as to appear seamless on curved surfaces. The appearance of high-resolution monitors can be simulated to provide detailed product information. Projected images can highlight product features, and visually show options such as color and texture.

Some of the sensors acquire real-time data reflecting consumer characteristics and behavior. A simple sensor is a proximity sensor for detecting a consumer's presence. These types of sensors can include passive IR sensors, active ‘break beam’ sensors, microwave motion detectors and capacitive proximity sensors. If the sensors include cameras, the acquired images can be analyzed to locate the consumers, and even implicit characteristics of the consumer, such as height, weight, gender, and race characteristics, the number of consumers in a group, all using conventional vision pattern recognition and vision systems.

Herein, implicit characteristics means characteristics that are measured, such as weight or gender, as opposed to explicit identifications used in prior art systems, such as name or number.

It should be noted that the system does not require explicit consumer identification, as in the prior art. For example, it can be determined which consumer is looking at which product, and the gender of the consumer. The images can also determine trajectories of consumers in the retail environment, i.e., what is the ‘shopping pattern’ of the consumer, is it quick, slow, directed, or random. The sensors can also detect heart rate and breathing rate. The sensed data is analyzed in real-time to determine an optimal presentation at any given moment, based on consumer characteristics such as height, gender, and age group rather than explicit knowledge of the individual.

For example, activated proximity sensors in a product or display shelf can initiate a particular stream of gender and age specific content at a display area on or near a product and the consumer. It is worth noting that the only action required of the consumer is normal shopping behavior. There are no devices for the consumer to carry and there is no explicit interface to manipulate or activate.

The sensed data, in combination with the preference model determine how the displays are updated. For example, if a consumer is observed leaving a product area, the display can be updated to entice the consumer back.

For example, the retail environment shown in FIG. 3 includes a wall unit with shelves 301 for placing product. The projector 101 is suitably arranged so as to project on all of the shelves. Each shelf has an embedded conductive material 302 that serves as a sense electrode for a capacitive proximity detector. These sense electrodes are connected to the processor 110, which allows the system to determine when a consumer is very near a shelf, as happens in the normal course of examining a product on a shelf. The display is updated to reflect the sensed data. In addition, an audio display can play background music, narration, and other sound effects under control of the system.

The programmed interaction of this system can range from simple to very complex. In the simplest case, the content, e.g., audio and video content, is in the form of preprogrammed loops that play in response to activation by the shelf proximity sensors. A more complex version considers a history of interactions. For example, if the system detects a preponderance of recent interactions with one product in particular by a particular class of consumers, then the system can provide more detailed product information, or otherwise update the display in an attempt to “close the sale.” If there have been no interactions for some period time, then the system can enter “attract mode,” presenting content specifically designed to attract consumers to the display.

The system can select appropriate content so as to optimize the chance of a sale. This can be done by trying different content, and learning how the different content correlate to observed consumer responses. For example, the system can learn that certain “attract mode” displays work better at different times of day, or on different days of the week, depending on the class of consumers. The system can also correlate consumer responses to specific content. The ability to optimize the presentation in real-time through sensor observation and historical reference is one feature of the invention.

A display can include multiple computer-controlled output devices. In this case, the output images are blended to form a large, seamless display image. Unlike the previous case where a certain area was set aside for the display, in this case, the projection fills the retail environment to a high degree.

The appearance of the space can thus be modified by simply changing the currently playing content. For example, at one moment, the store can appear to be a sophisticated, wood-paneled contemplative area, and at the next moment, it can appear to be a graffiti-covered brick alley.

By adding physically animated elements such as a moving wall, the effect of a morphable environment can be made even more realistic. In order to create undistorted displays, the geometry of the room is taken into account, and the projections suitably warped.

As in the case of the simple display, various theatrical, virtual signage, and virtual monitor effects can be created. However, in this example, the addition of a variety of sensors greatly enhances the interactive possibilities.

In particular, we add cameras throughout the environment to detect consumer presence, and to determine detailed consumer behavior and demographic and other characteristic information. This allows the system to determine when someone is looking at a display, determine their gender, race, approximate age, etc. and then provide optimal content. The camera system can use any of a variety of signal processing algorithms such as face detection and gender classification.

Other types of sensors can prove useful in ascertaining consumer characteristics and behavior. Height and weight sensors can help the system to highlight appropriately sized items for a given consumer. Physiologic sensors can determine heart rate and other variables that correlate to consumer excitement.

Projectors can simulate theatrical lighting. For example, projecting bright circular areas has the effect of appearing as multiple spotlights. Similarly, various patterns can be projected to mimic gobos and other common lighting effects. Text and pictures can be projected on a wall or shelf surface to mimic signage. Video monitors are commonly used in retail environments to show moving video content. These can be simulated by a projector. In fact, a single projector can mimic multiple virtual monitors at various locations across a display. In addition, the virtual monitors can appear and disappear as needed, move, and have arbitrary shapes. The projection surface need not be flat. In many cases, it is desirable to use the product itself as the projection surface to point out features or give other information such as an internal view of the product.

By using multiple adjoining images, the appearance of a large portion of the environment can be changed, e.g., a wall can at one moment appear as wood-paneled, and at a next moment as a graffiti-covered brick alley. By adding physically animated elements such as a moving wall, the effect of a changing environment can be made even more realistic. In order to generate undistorted displays, the geometry of the room is taken into account, and the projections can be suitably warped.

The database can also store real-time sales data, RFID information associated with products, inventory levels, and pricing and margin information. All of this data can be included in the analysis to determine the optimal way to update the display.

In addition to fixed content loops, the system can also include parameterizable content which can be programmatically modified in real-time as part of the overall optimization. Examples include the ability to occasionally have limited-time specials, where pricing is determined as part of the statistical optimization.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A display system for enhancing a retail environment, comprising:
a plurality of displays placed in a retail environment;
a plurality of sensors placed in the retail environment, the sensors configured to acquire implicit characteristics of consumers;
a database storing content and implicit preference models; and
means for updating the displays with the content in real-time according to the implicit characteristics of the consumers and the implicit preference models.

2. The retail system of claim 1, in which components of the displays are selected from the group consisting of projectors, audio outputs, signages, controllable mannequins, models, scent generators, and combinations thereof.

3. The retail system of claim 1, in which the sensors are selected from the group consisting of proximity sensors, infrared sensors, microphones, thermal sensors, cameras, touch sensors, and motion sensors.

4. The retail system of claim 1, further comprising:
determining consumer behavior in a vicinity of the displays; and
means for updating the displays with the content in real-time according to the consumer behavior.

5. The retail system of claim 1, in which the implicit consumer characteristics are selected from the group consisting of gender, height, weight, age, and race.

6. The retail system of claim 1, in which the sensors acquire environmental data from the retail environment.

7. The retail system of claim 1, in which the environmental data are selected from the group consisting of weather, traffic, time, date, pricing, and sales.

8. The retail system of claim 1, in which the retail environment includes three-dimensional structural elements, and further comprising:
means for projecting images on the three-dimensional structural elements.

9. The retail system of claim 1, in which the updating precludes an explicit identification of the consumers.

10. The retail system of claim 1, in which the updating is based on sensed shopping patterns of the consumers.

11. The retail system of claim 1, in which the sensors acquire heart rates and breathing rates of the consumers.

12. The retail system of claim 1, in which particular sensors are embedded in the retail environment.

13. The retail system of claim 1, in which the content includes audio and video signals.

14. The retail system of claim 1, in which the content is displayed according to a history of interactions between the consumers and the retail environment.

15. The retail system of claim 1, in which the content includes product information.

16. The retail system of claim 1, in which the content modifies an appearance of the retail environment.

17. The retail system of claim 1, in which a particular display simulates theatrical lighting.

18. The retail system of claim 1, in which a particular display simulates multiple video monitors with a single projector.

19. A method for enhancing a retail environment, comprising:
placing a plurality of displays in a retail environment;
placing a plurality of sensors in the retail environment, the sensors configured to acquire implicit characteristics of consumers;
storing content and implicit preference models in a database; and
updating the displays with the content in real-time according to the implicit characteristics of the consumers and the implicit preference models.
